(19) United States
(12) Patent Application Publication
(10) Pub. No.: US 2003/0070552 A1
(43) Pub. Date: Apr. 17, 2003

(54) Waste gas treating device

(76) Inventors: Chih-ming Lee, Kaohsiung (TW); Chih-hua Lee, Kaohsiung (TW); Chun-hung Lee, Kaohsiung (TW); Nan-ping Lee, Kaohsiung (TW)

Correspondence Address: DOUGHERTY & TROXELL, SUITE 1404, 5205 LEESBURG PIKE, FALLS CHURCH, VA, 22041, US

(21) Appl. No.: 09/975,261

(22) Filed: Oct. 12, 2001

(51) Int. Cl. B01D 53/14

(52) U.S. Cl. 96/290; 95/211

(57) ABSTRACT

A waste gas treating device includes two cleansing towers, a plurality of ceramic (or porcelain) balls fully filled in the two towers, and a specific liquid filled in the two towers for waste gas pumped in firstly in the first tower to flow upward through gaps among the ceramic balls and contact with the liquid. Then toxic substances in waste gas react with the liquid to produce byproducts, which sink down out of the first tower and then into a sediment pool. Partial waste gas flowing up to a top end of the first tower is pumped into the second tower for cleansing once again in the same process in the first one to let waste gas cleansed completely and flow out of an upper end of the second tower into atmosphere.

### BACKGROUND OF THE INVENTION

This invention relates to a waste gas treating device, particularly to one including two cleansing towers. The first cleansing tower has a special liquid and a plurality of ceramic (or porcelain) balls filled in a hollow interior so that waste gas fed in the tower may contact sufficiently with the liquid and outer surfaces of the ceramic balls in passing through very small gaps among the ceramic balls upward. Then toxic substances in waste gas may react with the liquid to produce byproducts, which then sink down to the lower portion and fall out of an outlet together with flying ashes in the liquid and fall down into a sediment pool and collected. Not completely cleansed waste gas flowing up out of a top end of the first tower is pumped in the second cleansing tower for cleansing once again in the same way. In the second cleansing tower is filled with a special liquid and a plurality of small ceramic balls, and waste gas becomes small bubbles between gaps among the ceramic balls after entering the second tower. Byproducts produced by waste gas reacting with the special liquid will sink down to a lower portion of the second tower and then be exhausted out into a sediment pool. Cleansed gas produced finally in the second tower flows upward and out of an outlet in an upper end connected to a chimney into atmosphere. Therefore, sour rain and greenhouse effect caused by carbon dioxide contained in waste gas coming out of factories can be decreased largely, alleviating serious pollution to the ecological environment and to human being. In addition, water vapor produced in the cleansing process can be recycled, and resultant byproducts of calcium carbonate and calcium sulfite can also be utilized as building material.

It is a well-known fact that waste gas exhausted by innumerable factories contain toxic substances such as sulfur dioxide and carbon dioxide, and the later causes sour rain to destroy buildings, crops, and forests in addition to greenhouse effect to possible give rise to alteration in the ecological system and world climate. Leaders of all the world are concerned about this problem, and UN sponsored international meetings for discussing about climate change caused by the greenhouse effect and called attention of all countries to reduce carbon dioxide released in atmosphere to a less level decided in the meetings.

### SUMMARY OF THE INVENTION

The objective of the invention is to offer a waste gas treating device for resolving an important problem of waste gas produced by innumerable factories, by using a special liquid for remov0ing toxic substances in waste gas by means of cleansing towers filled with the special liquid and many ceramic (or porcelain) balls having their outer surfaces contacting with waste gas. Then the ceramic balls recycle waste gas heat energy by absorbing and storing function. And at the same time, the waste gas treating device removes gaseous pollutants such as sulfuric acid, carbon dioxide and a solid pollutant such as flying ash contained in waste gas, and exhausts cleansed gas into atmosphere, reducing largely sour rain and greenhouse effect possible to cause serious impact to humane being. Besides, water vapor produced in treating process of waste gas can be recycled with a recycling device and utilized again, and byproducts such as calcium sulfite and calcium carbonate can be used as building material, which may form so called a green technological industry.

The feature of the invention involves at least two cleansing towers, a first one and a second one. The first cleansing tower is provided with a water-spraying device for spraying in a constant quantity a special liquid of mixed water containing lime and Butane dicarboxylic acid in ceramic (or porcelain) balls filled in the tower. Then the mixed water flow and contact with waste gas and through gaps among the ceramic balls and contact outer surfaces of the balls, falling down to an outlet in the bottom of the tower and finally into a sediment pool. Further, the first cleansing tower has an inlet in a sidewall of a lower portion for waste gas to flow into the first tower and gradually move upward to receive the treatment described above, producing by-products with specific substances contained in waste gas, and the byproducts together with flying ashes in waste gas sink down to an outlet in a lower end of the first tower. Partial waste gas flows upward through gaps among the ceramic balls and the specific liquid to an outlet in a top end of the first tower, and then forced in the second cleansing tower through an inlet in a sidewall of the second cleansing tower by a pump.

The second cleansing tower has an inlet in a sidewall of an upper portion for pouring the special liquid in a constant quantity in the two second cleansing tower also filled with ceramic balls, with the special liquid kept full in the second tower and having a level higher than that of the ceramic balls. Then waste gas passing through the first cleansing tower is pumped in the second cleansing tower, forming small bubbles between gaps among the ceramic balls and floating upward incessantly. Then waste gas may produce byproducts after sufficiently contacting and reacting with the mixed liquid, and the byproducts may sink down to an outlet in a lower end and flow out of the outlet. Cleansed gas after treated by the first and the second cleansing tower may flow to an outlet in a top end of the second cleansing tower and flow in atmosphere through a chimney connected to the outlet.

The waste gas treating device can remove sulfur oxide, carbon dioxide and flying ashes out of waste gas coming out of a great many factories and release cleansed gas into atmosphere, effectively lessening sour rain and greenhouse effect, which constitutes serious impact to biological environment and humane being. Besides, water vapor produced during cleansing process can be recycled and utilized by factories, and byproducts such as calcium carbonate, calcium sulfite may be used as building material, making up a green technological industry.

### BRIEF DESCRIPTION OF DRAWINGS

This invention will be better understood by referring to the accompanying drawings, wherein:

FIG. 1 is a flowing chart of a waste gas treating device in the present invention;

FIG. 2 is a cross-sectional view of a first cleansing tower in the waste gas treating device in the present invention;

FIG. 3 is a cross-sectional view of a second cleansing tower in the waste gas treating device in the present invention; and,

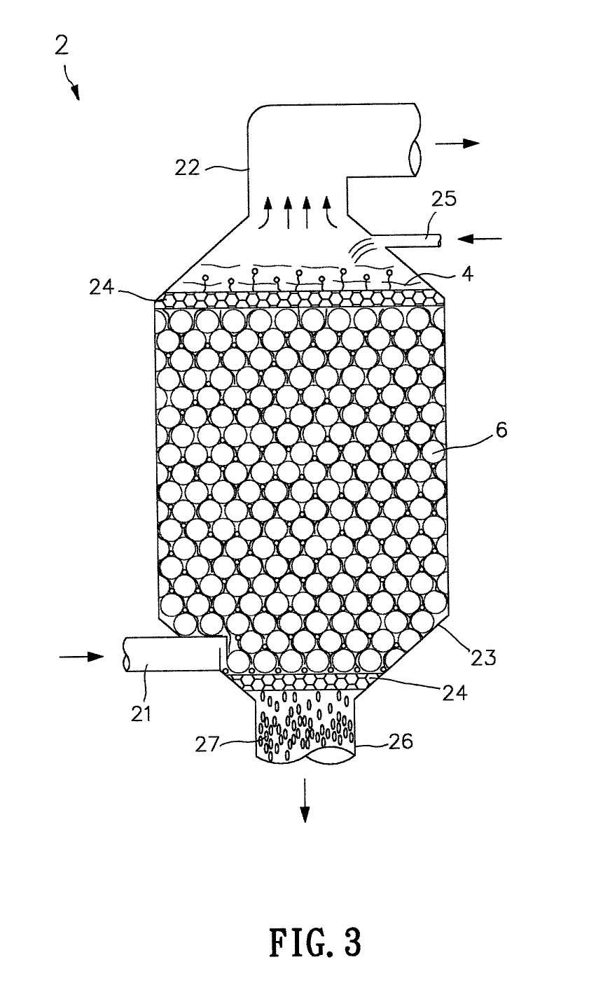

FIG. 4 is a cross-sectional view of a ceramic ball in the present invention.

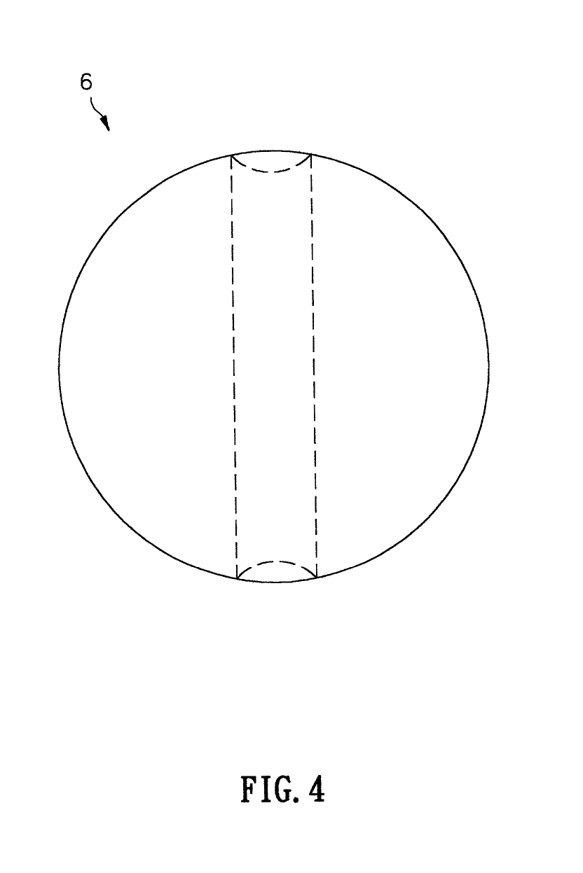

### DETAILED DESCRIPTION OF THE PREFERRED EMBODIMENTS

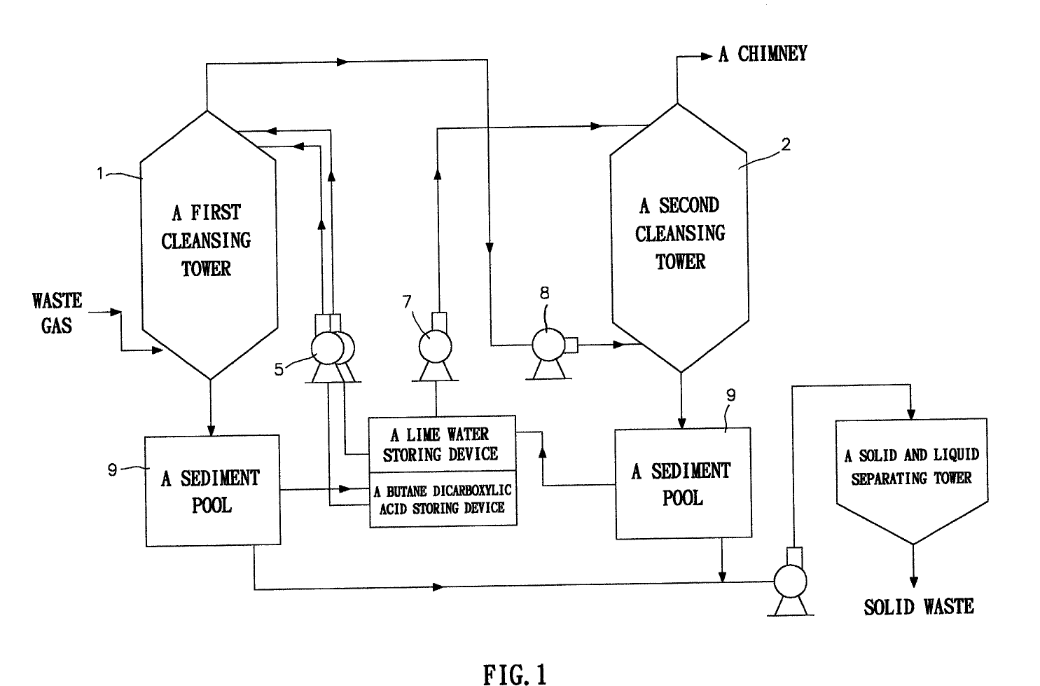

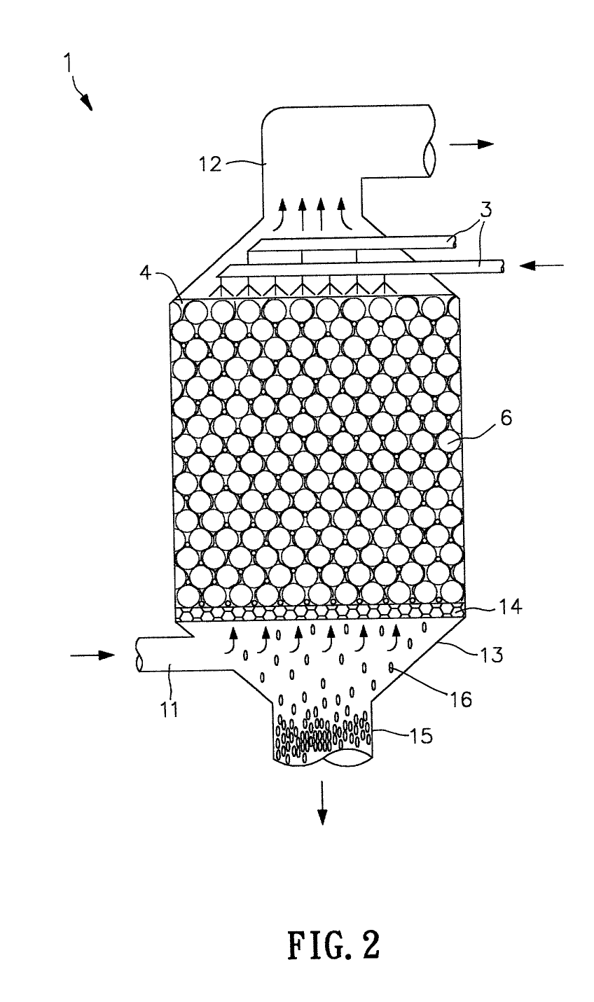

A first embodiment of a waste gas treating device in the present invention, as shown in FIGS. 1 and 2, includes a first cleansing tower 1 and a second cleansing tower 2 as main components.

The first and the second cleansing tower 1 and 2 are shaped almost the same, having respectively a funnel-shaped lower portion 13, 23. The first cleansing tower 1 has a water spraying device 3 fixed in an upper funnel-shaped portion for spraying constant quantity of special liquid 4 pumped in by a pump 5 on outer surfaces of small ceramic (or porcelain) balls 6 fully stored in the first cleansing tower 1, and the liquid 4 flows through gaps among the ceramic balls 6 and down to the bottom 13, The first tower 1 further has an acid-resistant, alkali-resistant and anti-rust metal plate net 14 horizontally located at an upper edge of the bottom 13 for supporting the ceramic balls 6. Further, the first tower 1 has a tube inlet 11 just under the metal net 14 for waste gas to be fed through and into the bottom of the first tower 1 for treating and then gradually flowing upward and out of an outlet 12 in a top end. The liquid 4 used in the first cleansing tower 1 is alkali plasma (preferably having 8 pH) of lime mixed with Butane dicarboxylic acid mainly for treating sulfur dioxide. Butane dicarboxylic acid functions to constrain the mixed liquid 4 not to let its pH value fall down by sulfur dioxide, increasing reactive force of the special liquid 4 and the sulfur dioxide. When the special liquid 4 is sprayed out on the upper portion of the first tower, Butane dicarboxylic acid reacts with the lime-water, producing calcium Butane dicarboxylic acid, which may fall down along the gaps among the ceramic balls 6 to the bottom of the first tower 1. Then calcium Butane dicarboxylic acid reacts with sulfurous acid to produce byproduct of calcium sulfite, which flows with the liquid 4 out of the outlet 15. Flying ashes contained in waste gas contact with the liquid 4 and flows down and out of the outlet 15 as the byproducts. Then calcium sulfite and the flying ashes together with the liquid 4 fall in a sediment pool 9 and sink down to be collected subsequently, and the special liquid 4 in the sediment 9 can also be recycled for use again.

Waste gas becomes mainly carbon dioxide and water vapor after cleansed by the first cleansing tower 1, and water vapor may be recycled according to necessity, and not completely cleansed waste gas coming out of the first cleansing tower 1 is forced into the second cleansing tower 2 by means of an air compressor 8. The second cleansing tower 2 has an pipe outlet 26 under the lower end and an acid-resistant, alkali-resistant and anti-rust metal plate net 24 fixed near the outlet 26 for preventing the ceramic balls 6 from falling out. Further, the second cleansing tower also has another acid-resistant, alkali-resistant and anti-rust metal plate net 24 fixed in an upper portion, and the space defined by the two metal plate nets 24 is fully filled with the ceramic balls 6. The second cleansing tower 2 further has an inlet 25 formed in a sidewall of an upper portion for the specific liquid 4 to flow in the second tower in a constant quantity by means of a pump 7. The specific liquid 4 in the second tower is kept fully filled with its level lower than the inlet 25, enabling the liquid 4 and byproduct 27 in the bottom 23 of the second tower 2 may flow continuously out of the outlet 26.

In the embodiment of the waste gas treating device in the invention, waste gas is shot in the specific liquid 4 through the pipe inlet 21 in the first cleansing tower 1 filled with the ceramic balls 6, forming bubbles in the liquid 4, and bubbles flow upward through gaps among the ceramic balls 6, increasing peripheral dimensions of the liquid 4 absorbing carbon dioxide, letting carbon dioxide react with the alkali lime plasma to produce a byproduct of calcium carbonate 27. Therefore, limewater must be incessantly added in the specific liquid 4 to keep calcium ion at a certain level.

Calcium carbonate 27, the byproduct produced during cleansing process, moves with the liquid 4 out of the outlet 26 into the sediment pool 9, and sink down on the bottom of the sediment pool 9 and is to be collected, and the liquid 4 remaining in the sediment pool 9 may be recycled for use again.

As to the ceramic balls 6, they are not glazed and have a center through hole for increasing surfaces to contact with the liquid 4 and waste gas so as to accordingly augment reaction of the waste gas with the liquid 4.

While the preferred embodiment of the invention has been described above, it will be recognized and understood that various modifications may be made therein and the appended claims are intended to cover all such modifications that may fall within the spirit and scope of the invention.

I Claim

1. A waste gas treating device at least comprising:
A first cleansing tower provided with a water spraying device in an upper portion to spray a constant quantity of a specific liquid pumped by a pump, a plurality of ceramic balls fully filled in an interior of said first cleaning tower, said specific liquid sprayed to flow through gaps among said ceramic balls and contacting outer surfaces of each said ceramic ball and falling down to an outlet formed to open down from a bottom of said first cleansing tower, a sediment pool provided below said first cleansing tower for receiving said liquid flowing out of said outlet, said first cleansing tower having an inlet formed in a sidewall of a lower portion for waste gas to flow through into said first cleansing tower, said waste gas flowing gradually upward contacting with said specific liquid and outer surfaces of said ceramic balls and moving up through gaps among said ceramic balls, said specific liquid absorbing toxic substances in said waste gas to produce a byproduct, said specific liquid also adhering to flying ashes in said waste gas, said byproduct and said flying ashes both sinking down gradually to move out of an outlet formed in a lower portion of said first cleansing tower, partial waste gas continuously flowing up through said gaps among said small ceramic balls to flow out of an outlet formed in a top end of said first cleansing tower, said partial waste gas flowing out of said outlet of said first cleansing tower and pumped to enter a second cleansing tower by means of a pump;
Said second cleansing tower having an inlet formed in a sidewall of a lower portion, an inlet formed in a sidewall of an upper portion, a plurality of ceramic balls fully filled in an interior, a specific liquid filled in said ceramic balls in said interior and kept full therein, said specific liquid having a level higher than that of said ceramic balls, said partial waste gas coming from said first cleansing tower and forming small bubbles in gaps among said ceramic balls and incessantly moving up and contacting with said specific liquid at the same time, a byproduct produced by said partial waste gas reacting with said specific liquid and gradually sinking down to move out of an outlet formed in said lower portion of said second cleansing tower, cleansed gas flowing up and out of an outlet formed in a top end of said second cleansing tower into atmosphere through a chimney connected to said outlet; and,
Said waste gas treating device removing said toxic substances in waste gas by making use of said specific liquid and said ceramic balls, said ceramic balls absorbing and storing heat so as to recycle waste heat energy, said waste gas treating device thus solving a problem of waste gas released by factories.

2. The waste gas treating device as claimed in claim 1, wherein both said first and said second cleansing tower have said lower portion funnel-shaped and an acid-resistant, alkali-resistant and anti-rust metal plate net fixed at an upper edge of said lower portion for supporting said ceramic balls.

3. The waste gas treating device as claimed in claim 1, wherein said special liquid is mixed with lime water and Butane dicarboxylic acid liquid, and said limewater has 8 pH.

4. The waste gas treating device as claimed in claim 1, wherein said ceramic balls are not glazed, respectively having a center through hole for increasing surface dimensions to contact said liquid and waste gas so as to augment reaction of said specific liquid with waste gas.
